(19) United States
(12) Patent Application Publication
(10) Pub. No.: US 2009/0187510 A1
(43) Pub. Date: Jul. 23, 2009

(54) Calculating Method for Systematic Risk

(76) Inventors: Kung-Hsiung Chang, Kaohsiung City (TW); Chin-Jen Sun, Pingdong County (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/266,590

(22) Filed: Nov. 7, 2008

(30) Foreign Application Priority Data
Jan. 22, 2008 (TW) 97102370
Oct. 31, 2008 (TW) 97142182

(51) Int. Cl. G06Q 40/00

(52) U.S. Cl. 705/36 R

(57) ABSTRACT

A calculating method for systematic risk comprises the steps of: calculating and obtaining predetermined number of true values of beta coefficient of a stock; establishing an original data series from the true values of beta coefficient; taking the accumulated generating operation (AGO) on the original data series to obtain a accumulated generating operation series; applying the MEAN operation to the accumulated generating operation series to obtain a mean series; using the original data series and the mean series to establish an grey differential equation; expressing the grey differential equation into a grey differential equation matrix; calculating particular parameters in the grey differential equation based on the least square method; applying the particular parameters into a whiting responsive equation to obtain a forecasting value of the accumulated generating operation series; and taking the inverse accumulated generating operation (IAGO) on the forecasting value of the accumulated generating operation series to obtain a forecasting value of beta coefficient.

### BACKGROUND OF THE INVENTION

1. Field of the Invention

The present invention relates to a calculating method for systematic risk, especially relating to a calculating method for systematic risk, which can enhance accuracy and stability of risk management.

2. Description of the Related Art

Most Taiwan investors invest their money in stocks. According to statistics of Taiwan stock exchange corporation (TSEC), 85% of investors in Taiwan stock market are retail investors who are too optimistic and self-confident and short of information for investing. Besides, the information that the retail investors get is may be wrong and not enough, so that the retail investors will overestimate their own abilities and underestimate the risk of investing stocks. Therefore, when certain investors make abnormal variations in stock prices, the retail investors will easily buy at high stock prices and sell at low stock prices to lose money.

There are unsystematic risk and systematic risk in the stock market. The unsystematic risk also known as company specific risk or diversifiable risk is unique to an individual asset, for example, news that is specific to a small number of stocks, such as legal proceedings, financial statements or winning a contract or not. This type of risk can be virtually eliminated from a portfolio through diversification. The systematic risk known as non-diversifiable risk is common to an entire class of assets or liabilities. The value of investments may decline over a given time period simply because of economic changes or other events that impact large portions of the market. Therefore, the systematic risk can't be reduced by diversifying the investment portfolio. In view of the above descriptions, if investors can predict the systematic risk in the future, they can change investing strategy before the stock market fluctuating, so that the return of investing the stock market is increased.

The systematic risk is represented by the beta coefficient (β) in terms of finance and investing. The beta coefficient describes how the expected return of a stock or portfolio is correlated to the financial market as a whole. It measures the part of the asset's statistical variance that cannot be mitigated by the diversification provided by the portfolio of many risky assets because it is correlated with the return of the other assets that are in the portfolio. In the theory of portfolio allocation under uncertainty published in 1952, Harry Max Markowitz developed the critical line algorithm for the identifications of the optimal mean-variance portfolios. Thereafter, many researchers studied how to estimate value of the beta coefficient in 1960s and 1970s and Capital Asset Pricing Model (CAMP) was introduced, which builded on the earlier work of Harry Max Markowitz. There are other models introduced to estimate systematic risk, such as Arbitrage Pricing Theory (APT) initiated by Stephen Ross in 1976. APT holds that the expected return of a financial asset can be modeled as linear function of various macro-economic factors. In contrast to the CAPM that has only one risk factor, namely the overall market, APT has multiple risk factors. Fama and Macbeth modified the CAMP to be a three-factor model in 1973. All these different models are used to estimate systematic risk effectively.

The value of beta coefficient differs from estimations by different models or methods. CAMP is based on many restrictive assumptions to use a too much simplified model to estimate true beta coefficient. For example, according to results of cross-sectional data of beta coefficient estimated by CAMP, Blume observed in 1970 that estimated beta was larger than true beta while the systematic risk was large and estimated beta was smaller than true beta while the systematic risk was small. Therefore, over fifty years, researchers dedicated themselves to increasing precision and stability of estimating beta coefficient and assisting in management of return and risk of a portfolio. Nevertheless, estimation of beta coefficient by any of said conventional models or methods described above is still not accurate and stable enough.

### SUMMARY OF THE INVENTION

The primary objective of this invention is to provide a calculating method for systematic risk, which uses grey prediction model to improve estimation of the systematic risk to diminish variation between an estimated value and a true value. Accordingly, the accuracy and stability of estimating systematic risk is improved.

The calculating method for systematic risk in accordance with an aspect of the present invention includes the steps of: calculating and obtaining predetermined number of true values of beta coefficient of a stock; establishing an original data series from the true values of beta coefficient; taking the accumulated generating operation (AGO) on the original data series to obtain a accumulated generating operation series; applying the MEAN operation to the accumulated generating operation series to obtain a mean series; using the original data series and the mean series to establish an grey differential equation; expressing the grey differential equation into a grey differential equation matrix; calculating particular parameters in the grey differential equation based on the least square method; applying the particular parameters into a whiting responsive equation to obtain a forecasting value of the accumulated generating operation series; and taking the inverse accumulated generating operation (IAGO) on the forecasting value of the accumulated generating operation series to obtain a forecasting value of beta coefficient.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating a calculating method for systematic risk in accordance with a preferred embodiment of the present invention.

FIG. 2 is another flow chart illustrating a calculating method for systematic risk in accordance with a preferred embodiment of the present invention.

### DETAILED DESCRIPTION OF THE INVENTION

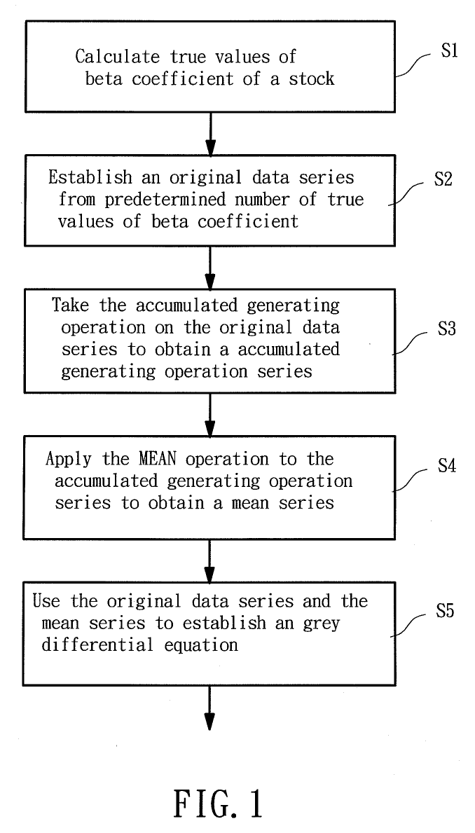

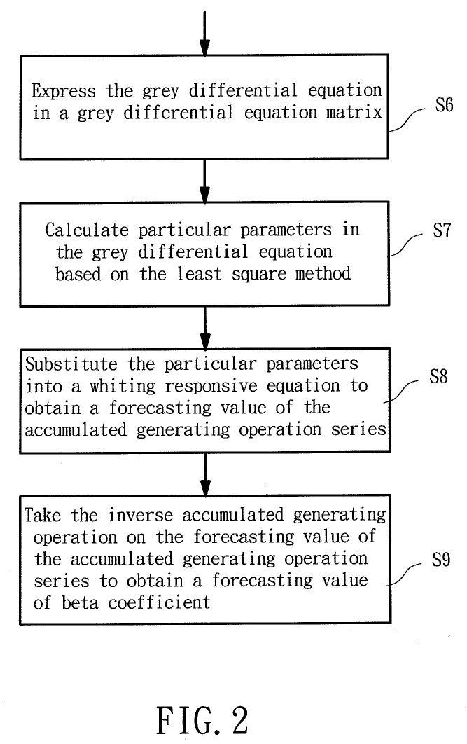

A calculating method for systematic risk of a preferred embodiment according to the preferred teachings of the present invention is shown in FIGS. 1 and 2. According to the preferred form shown, the calculating method for systematic risk includes the steps of: calculating and obtaining predetermined number of true values of beta coefficient of a stock designated as step “S1”; establishing an original data series from the true values of beta coefficient designated as step “S2”; taking the accumulated generating operation (AGO) on the original data series to obtain a accumulated generating operation series designated as step “S3”; applying the MEAN operation to the accumulated generating operation series to obtain a mean series designated as step “S4”; using the original data series and the mean series to establish an grey differential equation designated as step “S5”; expressing the grey differential equation into a grey differential equation matrix designated as step “S6”; calculating particular parameters in the grey differential equation based on the least square method designated as step “S7”; applying the particular parameters into a whiting responsive equation to obtain a forecasting value of the accumulated generating operation series designated as step “S8”; and taking the inverse accumulated generating operation (IAGO) on the forecasting value of the accumulated generating operation series to obtain a forecasting value of beta coefficient designated as step “S9”.

Referring again to FIG. 1, according to the step “S1”, calculations of true beta coefficient values are performed by the Fama-Macbeth regression model that is based on and modifies the Sharp's Capital Asset Pricing Model (CAPM).

Sharp's CAPM is derived from security market line (SML) as follows:

$$\begin{matrix}{r}_{it} = {r}_{f} + ( {r}_{mt} - {r}_{f} ) {β}_{i} \\ = {r}_{f} + {r}_{mt} {β}_{i} - {r}_{f} {β}_{i} \\ = ( 1 - {β}_{i} ) {r}_{f} + {r}_{m} {β}_{i} \\ = {α}_{i} + {r}_{mt} {β}_{i}\end{matrix}$$

$${β}_{i} = \frac{{σ}_{im}}{{σ}_{m}^{2}} = \frac{{\sum }_{t = 1}^{T} ( {r}_{it} - \overline{{r}_{t}} ) ( {r}_{mt} - \overline{{r}_{m}} )}{{\sum }_{t = 1}^{T} {( {r}_{mt} - \overline{{r}_{m}} )}^{2}}$$

Fama-Macbeth regression model is based on the above formula and modifies the CAPM as follows:

### Single-Factor Model:

rᵢₜ [symbol] r_{f}=(rₘₜ [symbol] r_{f})βᵢ+εᵢₜ

### Two-Factor Model:

rᵢₜ [symbol] r_{f}=(rₘₜ [symbol] r_{f})βᵢ+(rₘₜ [symbol] r_{f})^{¢±}βᵢ^{¢±}+εᵢₜ

where rᵢₜ represents the t-th return of the i-th stock;
r_{f} represents risk-free rate;
rₘₜ represents the t-th return of the market;
βᵢ represents systematic risk of the i-th stock; and
εᵢₜ represents regression deviation;

Referring again to FIG. 1, according to the step “S2”, the true values of beta coefficient are organized to establish the original data series y⁽⁰⁾, which is denoted as follows:

y⁽⁰⁾=(y⁽⁰⁾(1),Λ,y⁽⁰⁾(n))

where y⁽⁰⁾(k) means the k-th element in the original data series and k is 1, 2, . . . , or n.

And then, according to the step “S3”, the accumulated generating operation series y⁽¹⁾ is obtained by taking the accumulated generating operation (AGO) on the original data series which is denoted as follows:

y⁽¹⁾=(y⁽¹⁾(1),Λ,y⁽¹⁾(n))

where y⁽¹⁾(k) means the k-th element in the accumulated generating operation series and k is 1, 2, . . . , or n;

y⁽¹⁾(k)=y⁽¹⁾(k) [symbol] @ [symbol] Ak=1

y⁽¹⁾(k−1)+y⁽⁰⁾(k) [symbol] @ [symbol] Ak=2,Λ,n

In the step “S4”, the mean series z⁽¹⁾ is obtained by applying the MEAN operation to the elements y⁽¹⁾(k) in the accumulated generating operation series y⁽¹⁾. It is shown as follows:

z⁽¹⁾=(z⁽¹⁾(2),Λ,z⁽¹⁾(n))

where z⁽¹⁾(k) denotes the k-th element in the mean series;

z⁽¹⁾(k)=0.5(y⁽¹⁾(k)+y⁽¹⁾(k−1)) [symbol] @ [symbol] Ak=2,Λ,n

The grey differential equation g is established in the step “S5” by using the original data series y⁽⁰⁾ plus the mean series z⁽¹⁾ which is denoted as follows:

g [symbol] ^{y}^{⁽⁰⁾}^{(k)+az}^{⁽¹⁾}^{(k)=u}

where the parameters, a and u, are called the development coefficient and the gray input respectively while a and u are both particular parameters determined in the following steps. Referring to FIG. 2, following the step “S5” is the step “S6” in which the grey differential equation g is expressed into the grey differential equation matrix G

[symbol]

G [symbol] B\grave{θ}=Y

$$where B = [ \begin{matrix}- {z}^{( 1 )} ( 2 ) & 1 \\ - {z}^{( 1 )} ( 3 ) & 1 \\ M & 1 \\ - {z}^{( 1 )} ( n ) & 1\end{matrix} ] , \\ {θ}^{)} = [ \begin{matrix}a \\ u\end{matrix} ] ;$$

$$Y [ \begin{matrix}{y}^{( 0 )} ( 2 ) \\ {y}^{( 0 )} ( 3 ) \\ M \\ {y}^{( 0 )} ( n )\end{matrix} ] .$$

And then, the calculation of the particular parameters, a and u, can be obtained by the least square method in the step “S7”:

$${θ}^{)} = [ \begin{matrix}a \\ u\end{matrix} ] = {( {B}^{T} B )}^{- 1} {B}^{T} Y$$

After the step “S7”, the step “S8” is provided for obtaining the forecasting value ŷ⁽¹⁾(n+p) of the accumulated generating operation series y⁽¹⁾, while the calculated particular parameters, a and u, are applied into the whiting responsive equation w denoted as follows:

$$w • {\hat{y}}^{( 1 )} ( n + p ) = ( {y}^{( 0 )} ( 1 ) - \frac{u}{a} ) \cdot {e}^{- a ( n + p - 1 )} + \frac{u}{a}$$

where “̂” means the value is forecasted and a parameter “p” is the forecasting step-size.

Lastly in the step “S9”, the forecasting value ŷ⁽⁰⁾(n+p) of the true values of beta coefficient is obtained by taking the inverse accumulated generating operation (IAGO) on the forecasting value ŷ⁽¹⁾(n+p):

$$\begin{matrix}{\hat{y}}^{( 0 )} ( n + p ) = {\hat{y}}^{( 1 )} ( n + p ) - {\hat{y}}^{( 1 )} ( n + p - 1 ) \\ = ( {y}^{( 0 )} ( 1 ) - \frac{u}{a} ) ( 1 - {e}^{a} ) \cdot {e}^{a ( n + p - 1 )}\end{matrix}$$

To verify the proposed calculating method for systematic risk, the Taiwan Stock Exchange Capitalization (TSEC) Taiwan 50 Index is used for reducing the influence of artificially manipulating share prices on the systematic value of the verification. Therefore, rᵢₜ represents return of each stock and is calculated by the following formula:

[(today's closing price of the stock)−(closing price of last trading day of the stock)]/(closing price of last trading day of the stock)×100%;

and rₘₜ represents return of the market and is calculated by the following formula:

[(today's closing index of the Taiwan weighted stock index)−(closing index of last trading day of the Taiwan weighted stock index)]/(closing index of last trading day of the Taiwan weighted stock index)×100%

Table 1 shows the constituent names of the TSEC Taiwan 50 Index and some constituents of the table 1 are eliminated to form table 2. The data of announced indices of Taiwan Stock Exchange Capitalization was collected from Jan. 6, 1997 to Dec. 29, 2006. The data of a three-month period from Jan. 6, 1997 to Mar. 31, 1997 are for forecasting the result of a verifying period from Apr. 1, 1997 to Jun. 30, 1997 and Grey rolling model is performed to form 118 time-subsets each of which is continuous three-month period. Besides, for avoiding sampling the data unprecisely caused by ex-right, ex-dividend or employees' shares due to profit sharing, data of the days of ex-right, ex-dividend and employees receiving shares are returned to the original values thereof.

TABLE 1
Constituent Names of TSEC Taiwan 50 Index

| Local | |
|---|---|
| Identifier | Constituent Name |
| 1101 | Taiwan Cement |
| 1102 | Asia Cement |
| 1216 | Uni-president |
| | Enterprises |
| 1301 | Formosa Plastics |
| | Corp |
| 1303 | Nan Ya Plastics |
| 1326 | Formosa |
| | Chemicals & Fibre |
| 1402 | Far Eastern Textile |
| 2002 | China Steel |
| 2301 | Lite-On |
| | Technology |
| 2303 | United |
| | Microelectronics |
| 2308 | Delta Electronics |
| 2311 | Advanced |
| | Semiconductor |
| | Engineering |
| 2317 | Hon Hai Precision |
| | Industry |
| 2323 | Cmc Magnetics |
| | Corporation |
| 2324 | Compal |
| | Electronics |
| 2325 | Siliconware |
| | Precision |
| | Industries |
| 2330 | Taiwan |
| | Semiconductor |
| | Manufacturing |
| 2337 | Macronix |
| | International |
| 2357 | Asustek Computer |
| | Inc |
| 2344 | Winbond |
| | Electronics |
| 2408 | Nanya Technology |
| 2409 | AU Optronics |
| 2412 | Chunghwa Telecom |
| 2352 | Qisda |
| 2356 | Inventec |
| | Corporation |
| 2603 | Evergreen Marine |
| 2801 | Chang Hwa |
| | Commercial Bank |
| 2880 | Hua Nan Financial |
| | Holdings |
| 2881 | Fubon Financial |
| | Holdings |
| 2882 | Cathay Financial |
| | Holding |
| 2883 | China Development |
| | Financial Holdings |
| 2884 | E.Sun Financial |
| | Holding |
| 2609 | Yang Ming Marine |
| | Transport |
| 2886 | Mega Financial |
| | Holding |
| 2887 | Taishin Financial |
| | Holdings |
| 2888 | Shin Kong |
| | Financial Holding |
| 2890 | SinoPac Financial |
| | Holdings Co. Ltd. |
| 2891 | Chinatrust |
| | Financial Holding |
| 2892 | First Financial |
| | Holding |
| 2912 | President Chain |
| | Store |
| 3009 | Chi Mei |
| | Optoelectronics |
| 2610 | China Airlines |
| 3045 | Taiwan Cellular |
| 3474 | Inotera Memories |
| 3481 | InnoLux Display |
| 4904 | Far EasTone |
| | Telecommunications |
| 5854 | Taiwan |
| | Cooperative Bank |
| 6505 | Formosa |
| | Petrochemical |
| 8046 | Nan Ya Printed |
| | Circuit Board |
| 9904 | Pou Chen |

TABLE 2
some Constituent Names of TSEC Taiwan 50 Index of the table 1 after
elimination

| Local | |
|---|---|
| Identifier | Constituent Name |
| 1216 | Uni-president |
| | Enterprises |
| 1301 | Formosa Plastics |
| | Corp |
| 1303 | Nan Ya Plastics |
| 1326 | Formosa |
| | Chemicals & Fibre |
| 1402 | Far Eastern Textile |
| 2002 | China Steel |
| 2105 | Cheng Shin |
| | Rubber Industry |
| 2201 | Yulon Motor Co. |
| 2204 | China Motor |
| 2301 | Lite-On |
| | Technology |
| 2303 | United |
| | Microelectronics |
| 2308 | Delta Electronics |
| 2311 | Advanced |
| | Semiconductor |
| | Engineering |
| 2317 | Hon Hai Precision |
| | Industry |
| 2323 | Cmc Magnetics |
| | Corporation |
| 2324 | Compal |
| | Electronics |
| 2325 | Siliconware |
| | Precision |
| | Industries |
| 2330 | Taiwan |
| | Semiconductor |
| | Manufacturing |
| 2337 | Macronix |
| | International |
| 2344 | Winbond |
| | Electronics |
| 2352 | Qisda |
| 2353 | Acer |
| 2356 | Inventec Co. |
| 2357 | Asustek Computer |
| | Inc |
| 2603 | Evergreen Marine |
| 2609 | Yang Ming |
| | Marine Transport |
| 2610 | China Airlines |
| 2801 | Chang Hwa |
| | Commercial Bank |
| 9904 | Pou Chen |

The average deposit interest rate of the largest five banks (Taiwan Business Bank, Taiwan Cooperative Bank, Chang Hwa Commercial Bank, First Commercial Bank and Hua Nan Bank) is adopted as substitute for risk-free rate because the analyzed data are collected from Taiwan stock market. According to the formulas described above, return of each stock and return of the market are calculated, and the calculations thereof and risk-free rate are taken into the Fama-Macbeth regression model to obtain values of beta coefficient through the single-factor model and two-factor model.

For performing the calculating method for systematic risk of the present invention and comparing the results thereof with other methods, daily return of each stock and daily return of the market are collected for estimating beta coefficient based on Fama-Macbeth regression model, with the collecting period is three months.

In the preferred embodiment of the present invention, values of the beta coefficient respectively are estimated based on Fama-Macbeth regression model modifying CAPM (step S1) plus the whiting process (steps S2-S9) and the estimated values of beta coefficient are compared with the true ones to obtain forecasting accuracy. In addition to the calculating method for systemic risk of the present invention, with the TSEC Taiwan 50 Index, there are four other compared methods are provided as follows.

First is the conventional calculating method for systemic risk designated as original prediction model that is abbreviated to OM₁ and on the basis of original return of the stock and original return of the market. In the OM₁, returns of the stock and the market are calculated from original data of the TSEC Taiwan 50 Index to estimate the beta coefficient values by single-factor model (designate as OM₁¹) and two-factor model (designate as OM₁²) respectively. Second is a beta prediction model designated as grey prediction model □ that is abbreviated to GM₁ and on the basis of whiten return of the stock and original return of the market. In the GM₁, return of the stock and return of the market are calculated respectively from whiten closing prices through the grey prediction and original closing index to estimate the beta coefficient values by single-factor model (designate as GM₁¹) and two-factor model (designate as GM₁²) respectively.

Third is another beta prediction model designated as grey prediction model □ that is abbreviated to GM₂ and on the basis of original return of the stock and whiten return of the market. In the GM₂, return of the stock and return of the market are calculated respectively from original closing prices and whiten closing index through the grey prediction to estimate the beta coefficient values by single-factor model (designate as GM₂¹) and two-factor model (designate as GM₂²) respectively.

Fourth is the other beta prediction model designated as grey prediction model □ that is abbreviated to GM₃ and on the basis of whiten return of the stock and whiten return of the market. In the GM₃, returns of the stock and the market calculated from original closing prices and original closing index are whiten through the grey prediction to estimate the beta coefficient values by single-factor model (designate as GM₃¹) and two-factor model (designate as GM₃²) respectively.

Fifth is beta prediction model according to the preferred teachings of the present invention designated as grey prediction model □ that is abbreviated to GM₄ and on the basis of whiten beta coefficient value. In the GM₄, returns of the stock and the market are calculated from original closing prices and original closing index to estimate the beta coefficient values by single-factor model (designate as GM₄¹) and two-factor model (designate as GM₄²) of the step S1 respectively and then the estimated beta coefficient values of GM₄¹ and GM₄² are both whiten through the steps S2-S9 of the present invention.

As shown in Table 3, beta coefficient values are obtained under ten conditions based on OM₁, GM₁, GM₂, GM₃ and GM₄ respectively combined with the single- and two-factor models. Besides, with the ten-year data of the TSEC Taiwan 50 Index, each of the ten conditions can produce 118 beta coefficient values.

TABLE 3
beta prediction under the ten conditions

| abbreviation | type | procedure |
|---|---|---|
| OM₁¹ | original prediction | Performing the single-factor model with original return |
| | model with | of the stock and original return of the market of a |
| | single-factor model | three-month data to forecast beta coefficient value of |
| | | the next three months. |
| OM₁² | original prediction | Performing the two-factor model with original return of |
| | model with | the stock and original return of the market of a |
| | two-factor model | three-month data to forecast beta coefficient value of |
| | | the next three months. |
| GM₁¹ | grey prediction | Performing the single-factor model with return of the |
| | model □ with | stock from whiten closing prices and return of the |
| | single-factor model | market from original closing index of five constituents |
| | | of the TSEC Taiwan 50 Index in a three-month period |
| | | to forecast beta coefficient value of the next three |
| | | months. |
| GM₁² | grey prediction | Performing the two-factor model with return of the |
| | model □ with | stock from whiten closing prices and return of the |
| | two-factor model | market from original closing index of five constituents |
| | | of the TSEC Taiwan 50 Index in a three-month period |
| | | to forecast beta coefficient value of the next three |
| | | months. |
| GM₂¹ | grey prediction | Performing the single-factor model with return of the |
| | model [symbol] with | stock from original closing prices and return of the |
| | single-factor model | market from whiten closing index of five constituents |
| | | of the TSEC Taiwan 50 Index in a three-month period |
| | | to forecast beta coefficient value of the next three |
| | | months. |
| GM₂² | grey prediction | Performing the two-factor model with return of the |
| | model [symbol] with | stock from original closing prices and return of the |
| | two-factor model | market from whiten closing index of five constituents |
| | | of the TSEC Taiwan 50 Index in a three-month period |
| | | to forecast beta coefficient value of the next three |
| | | months. |
| GM₃¹ | grey prediction | Performing the single-factor model with whiten returns |
| | model [symbol] with | of the stock and the market from original closing prices |
| | single-factor model | and closing index of five constituents of the TSEC |
| | | Taiwan 50 Index in a three-month period to forecast |
| | | beta coefficient value of the next three months. |
| GM₃² | grey prediction | Performing the two-factor model with whiten returns of |
| | model [symbol] with | the stock and the market from original closing prices |
| | two-factor model | and closing index of five constituents of the TSEC |
| | | Taiwan 50 Index in a three-month period to forecast |
| | | beta coefficient value of the next three months. |
| GM₄¹ | grey prediction | Performing the single-factor model with returns of the |
| | model [symbol] with | stock and the market from original closing prices and |
| | single-factor model | closing index of four constituents of the TSEC Taiwan |
| | | 50 Index in a three-month period to obtain a true beta |
| | | coefficient value, and whiting the beta coefficient value |
| | | to forecast beta coefficient value of the next three |
| | | months. |
| GM₄² | grey prediction | Performing the two-factor model with returns of the |
| | model [symbol] with | stock and the market from original closing prices and |
| | two-factor model | closing index of four constituents of the TSEC Taiwan |
| | | 50 Index in a three-month period to obtain a true beta |
| | | coefficient value, and whiting the beta coefficient value |
| | | to forecast beta coefficient value of the next three |
| | | months. |

For determining difference between each forecasted beta coefficient value of the ten conditions and true beta value, the forecast accuracy, namely forecast error, is measured. The forecasting abilities of the ten conditions in Table 3 are summarized by Theil's U, which is a statistical measure for the assessment of the forecast quality. The Theil's U is computed as:

$$Theil ' s U = RMSE / {[ ( 1 / T ) {\sum }_{t = 1}^{T} {A}_{t}^{2} ]}^{0.5}$$

where RMSE is root mean squared errors and is computed as:

$$RMSE = {[ ( 1 / T ) {\sum }_{t = 1}^{T} {( {A}_{t} - {F}_{t} )}^{2} ]}^{0.5}$$

where T represents number of forecasting period; Aₜ represents true beta value and Fₜ represents forecasted beta value of each conditions of Table 3.

The Theil's U and RMSE are used to compare relative forecast performances across different models. The Theil's U value of 1 will be obtained when a forecast applies the simple no-change model. The Theil's U value greater than 1 indicates that the forecasting method used is only of little use and as worse that the native method. When the forecast beta coefficient value is equal to the true beta value, the Theil's U value of 0 will be obtained. The more the Theil's U value is close to zero, the higher the forecast accuracy is. The Theil's U values of the OM₁¹, GM₁¹, GM₂¹, GM₃¹ and GM₄¹ are presented in Table 4.

For calculating beta coefficient by single-factor model, the average Theil's U values of the 29 constituents with the OM₁¹, GM₁¹, GM₂¹, GM₃¹ and GM₄¹ are 13.0079%, 18.1806%, 38.2159%, 26.4424% and 11.2437% respectively, with the average Theil's U value of the GM₄¹ being close to zero most. According to the results shown in Table 4, the Theil's U values of the GM₂¹ and GM₃¹ are significantly higher than those of the others and it indicates that only whiting either return of the stock or return of the market during analyzing the beta value causes a lower forecasting accuracy. However, OM₁¹ with original return of the stock and original return of the market, GM₃¹ with whiten returns of the stock and whiten returns of the market and GM₄¹ with the true beta value cause higher forecasting accuracy. In particular, for the 29 constituents in Table 4, Theil's U values of the GM₄¹ are the lowest. Therefore, forecasting accuracy of the GM₄¹ is the best.

TABLE 4
Theil's U values of 29 constituents (TSEC Taiwan 50 Index) based
on OM₁¹, GM₁¹, GM₂¹, GM₃¹ and GM₄¹

| | OM₁¹ | GM₁¹ | GM₂¹ | GM₃¹ | GM₄¹ |
|---|---|---|---|---|---|
| 1216 | 10.8910%* | 14.3382% | 35.2022% | 24.9103% | 8.2636%** |
| 1301 | 10.7564%* | 14.0874% | 35.2424% | 25.9672% | 8.9863%** |
| 1303 | 10.7309%* | 17.7046% | 35.8468% | 25.8508% | 8.1393%** |
| 1326 | 13.8245%* | 15.1811% | 35.0238% | 24.1908% | 10.5016%** |
| 1402 | 17.4669%** | 18.9282% | 38.1863% | 24.0708%* | 18.6114%* |
| 2002 | 11.3841%* | 13.0022% | 33.6022% | 25.7431% | 9.3101%** |
| 2105 | 12.8760%* | 13.3164% | 33.0055% | 24.1649% | 9.3017%** |
| 2201 | 11.1612%* | 13.6102% | 32.8959% | 21.1747% | 8.8960%** |
| 2204 | 10.3918%* | 12.4059% | 34.4328% | 25.0641% | 9.0288%** |
| 2301 | 13.2431%* | 16.3542% | 39.5127% | 23.9209% | 9.4111%** |
| 2303 | 14.0118%* | 20.3762% | 43.9159% | 28.8220% | 9.8288%** |
| 2308 | 11.9967%* | 16.1739% | 39.7306% | 28.6990% | 7.3412%** |
| 2311 | 10.5640%* | 15.2265% | 43.9994% | 27.9107% | 8.1270%** |
| 2317 | 10.9364%* | 52.0180% | 39.1592% | 45.7727% | 8.8293%** |
| 2323 | 12.0671%** | 17.5527% | 38.5053% | 24.0086% | 16.3399%* |
| 2324 | 13.2530%** | 14.8592%* | 41.8913% | 28.8103% | 16.3520% |
| 2325 | 14.5038%** | 18.6231% | 44.7724% | 25.9376% | 15.1779%* |
| 2330 | 10.0438%* | 13.9761% | 42.6348% | 28.7885% | 8.1270%** |
| 2337 | 24.3292%* | 29.7335% | 40.0730% | 27.0244% | 20.2987%** |
| 2344 | 13.7866%* | 18.8562% | 44.4345% | 29.9395% | 9.6153%** |
| 2352 | 12.8552%** | 15.6451% | 42.1808% | 28.2356%* | 14.8604%* |
| 2353 | 13.3719%* | 15.2614% | 39.5686% | 27.1476% | 10.2204%** |
| 2356 | 12.3030%* | 14.0661% | 39.2553% | 27.2659% | 9.5424%** |
| 2357 | 10.9364%* | 18.1699% | 39.5278% | 26.1027% | 8.8293%** |
| 2603 | 16.5267%* | 20.7007% | 34.5680% | 24.5728% | 11.6433%** |
| 2609 | 17.2403%* | 19.4958% | 44.3577% | 24.5417% | 13.0963%** |
| 2610 | 16.0736%** | 16.4038%* | 23.8278% | 22.8196%* | 20.7560% |
| 2801 | 9.3646%* | 14.1159% | 36.1247% | 21.2438% | 8.4247%** |
| 9904 | 10.3389%* | 27.0555% | 36.7848% | 24.1282% | 8.2086%** |
| average | 13.0079%* | 18.1806% | 38.2159% | 26.4424% | 11.2437%** |

note [symbol]
** is the best forecasting accuracy [symbol]
* means the forecasting accuracy is inferior to the best forecast accuracy.

The forecast performances of GM₄¹ of the present invention relative to OM₁¹, GM₁¹, GM₂¹, and GM₃¹ are shown in Table 5. Taking the forecast performance of GM₄¹ relative to OM₁¹ for example, it is calculated by subtracting the Theil's U value of GM₄¹ from that of OM₁¹, and then the result being divided by Theil's U value of OM₁¹. The average forecast performances of GM₄¹ of the present invention relative to OM₁¹, GM₁¹, GM₂¹, and GM₃¹ are 14.0957%, 33.9165%, 69.8058% and 56.4347% respectively, and it is shown that the forecasting accuracy of GM₄¹ is much better than those of the others.

TABLE 5
The forecast performances of GM₄¹ relative to OM₁¹, GM₁¹,
GM₂¹, and GM₃¹ (TSEC Taiwan 50 Index)

| | OM₁¹ | GM₁¹ | GM₂¹ | GM₃¹ |
|---|---|---|---|---|
| 1216 | 24.1245% | 42.3669% | 76.5255% | 66.8268% |
| 1301 | 16.4569% | 36.2105% | 74.5015% | 65.3937% |
| 1303 | 24.1508% | 54.0271% | 77.2942% | 68.5143% |
| 1326 | 24.0358% | 30.8241% | 70.0157% | 56.5883% |
| 1402 | −6.5522% | 1.6736% | 51.2616% | 22.6807% |
| 2002 | 18.2185% | 28.3963% | 72.2933% | 63.8347% |
| 2105 | 27.7596% | 30.1488% | 71.8179% | 61.5075% |
| 2201 | 20.2950% | 34.6369% | 72.9570% | 57.9873% |
| 2204 | 13.1166% | 27.2219% | 73.7785% | 63.9772% |
| 2301 | 28.9364% | 42.4549% | 76.1822% | 60.6576% |
| 2303 | 29.8537% | 51.7634% | 77.6191% | 65.8983% |
| 2308 | 38.8070% | 54.6112% | 81.5226% | 74.4201% |
| 2311 | 23.0685% | 46.6257% | 81.5292% | 70.8821% |
| 2317 | 19.2667% | 83.0264% | 77.4527% | 80.7105% |
| 2323 | −35.4087% | 6.9097% | 57.5646% | 31.9415% |
| 2324 | −23.3836% | −10.0460% | 60.9657% | 43.2426% |
| 2325 | −4.6478% | 18.4997% | 66.1000% | 41.4832% |
| 2330 | 19.0840% | 41.8503% | 80.9380% | 71.7698% |
| 2337 | 16.5665% | 31.7311% | 49.3456% | 24.8875% |
| 2344 | 30.2565% | 49.0075% | 78.3608% | 67.8843% |
| 2352 | −15.5983% | 5.0161% | 64.7698% | 47.3701% |
| 2353 | 23.5683% | 33.0311% | 74.1705% | 62.3526% |
| 2356 | 22.4386% | 32.1602% | 75.6914% | 65.0024% |
| 2357 | 19.2667% | 51.4068% | 77.6629% | 66.1746% |
| 2603 | 29.5489% | 43.7542% | 66.3178% | 52.6172% |
| 2609 | 24.0366% | 32.8251% | 70.4757% | 46.6367% |
| 2610 | −29.1310% | −26.5316% | 12.8916% | 9.0432% |
| 2801 | 10.0359% | 40.3173% | 76.6787% | 60.3426% |
| 9904 | 20.6048% | 69.6601% | 77.6848% | 65.9792% |
| average | 14.0957% | 33.9165% | 69.8058% | 56.4347% |

According to average Theil's U values and Friedman's chi-square distribution statistics under ten conditions based on OM₁, GM₁, GM₂, GM₃ and GM₄ respectively combined with the single- and two-factor models, it is known that forecasting accuracy of GM₄¹ is most reliable, with average Theil's U value of 11.2437% and Friedman's chi-square distribution statistics of 23 in 29 constituents falling with a range smaller than 15%. Thus, to determine the stability of forecasted beta coefficient values, analysis of variance of two populations is performed in which variance in differences between forecasted beta coefficient values and true beta coefficient values of GM₄¹ is compared with the others respectively.

Referring to Table 6, the result of analysis of variance comparing GM₄¹ with OM₁¹ shows that there are 12 in 29 constituents of GM₄¹ having error variances smaller than those of OM₁¹, with the significance level being set at 0.05. The result of analysis of variance comparing GM₄¹ with GM₃¹ shows that there are 19 in 29 constituents of GM₄¹ having error variances smaller than those of GM₃¹, with the significance level being set at 0.05. The result of analysis of variance comparing GM₄¹ with OM₁² shows that there are 26 in 29 constituents of GM₄¹ having error variances smaller than those of OM₁², with the significance level being set at 0.05. Furthermore, the results of analysis of variance comparing GM₄¹ with GM₁¹ and GM₂¹ show that there are 23 and 27 in 29 constituents of GM₄¹ having error variances smaller than those of GM₁¹ and GM₂¹, with the significance level being set at 0.01. Lastly, the results of analysis of variance comparing GM₄¹ with OM₁², GM₁², GM₂², GM₃², and GM₄² show that all constituents of GM₄¹ have error variances smaller than those of OM₁², GM₁², GM₂², GM₃², and GM₄², with the significance level being set at 0.01. Based on the results described above, GM₄¹ has least variation in forecast, namely GM₄¹ has best reliability.

TABLE 6
Results of analysis of variance by comparing GM₄¹ with the others (TSEC Taiwan 50 Index)

| | OM₁¹ | OM₁² | GM₁¹ | GM₁² | GM₂¹ | GM₂² | GM₃¹ | GM₃² | GM₄² |
|---|---|---|---|---|---|---|---|---|---|
| 1216 | 4.578** | 146.7** | 13.096** | 3.E+05** | 214.1** | 5.E+05** | 42.44** | 5.E+04** | 271.3** |
| 1301 | 2.318* | 89.4** | 32.539** | 6.E+04** | 122.8** | 5.E+05** | 35.32** | 171.936** | 2.E+03** |
| 1303 | 10.42** | 306.1** | 51.468** | 2.E+06** | 575.2** | 4.E+06** | 222.4** | 1.E+06** | 706.672** |
| 1326 | 3.087** | 488.5** | 15.141** | 5.E+05** | 368.1** | 8.E+05** | 105.6** | 1.E+05** | 2.E+06** |
| 1402 | 2.613** | 328.1** | 1.E+04** | 3.E+04** | 207.7** | 3.E+05** | 5E+03** | 1.E+04** | 1.E+03** |
| 2002 | 0.038 | 1.220 | 0.084 | 7.388** | 2.132* | 1.E+03** | 0.500 | 18.477** | 2.034* |
| 2105 | 0.300 | 1.304 | 0.285 | 2.E+03** | 3.526** | 8.E+03** | 1.069 | 9.E+03** | 4.755** |
| 2201 | 0.457 | 15.1** | 0.741 | 1.E+04** | 9.392** | 944.492** | 1.976* | 3.E+03** | 6.E+03** |
| 2204 | 0.914 | 59.9** | 3.680** | 577.565** | 178.5** | 4.E+05** | 54.151** | 5.E+05** | 77.579** |
| 2301 | 1.945 | 9.5** | 3.832** | 427.158** | 4.421** | 7.E+03** | 1.167 | 1.E+03** | 1.E+03** |
| 2303 | 2.366* | 194.9** | 11.015** | 3.E+05** | 197.3** | 529.337** | 54.286** | 6.E+04** | 218.637** |
| 2308 | 0.465 | 3.26** | 0.585 | 5.E+03** | 4.532** | 8.E+03** | 1.508 | 678.093** | 9.363** |
| 2311 | 2.770** | 225.** | 4.282** | 4.E+04** | 136.4** | 7.E+05** | 46.762** | 2.E+04** | 3.E+06** |
| 2317 | 1.856 | 36.6** | 6.474** | 2.E+04** | 105.1** | 2.E+05** | 34.982** | 2.E+04** | 79.745** |
| 2323 | 2.613** | 328.1** | 50.120** | 5.E+05** | 248.0** | 1.E+06** | 72.381** | 2.E+04** | 4.E+05** |
| 2324 | 3.457** | 25.9** | 14.492** | 225.546** | 34.38** | 1.E+05** | 19.162** | 1.E+03** | 132.419** |
| 2325 | 3.023** | 11.9** | 5.003** | 30.361** | 157.5** | 3.E+03** | 5.495** | 85.490** | 75.893** |
| 2330 | 0.103 | 1.878 | 0.059 | 15.665** | 0.396 | 2.618** | 0.399 | 1.978* | 6.151** |
| 2337 | 1.082 | 41.8** | 12.281** | 916.616** | 147.3** | 3.E+05** | 24.505** | 916.122** | 103.243** |
| 2344 | 1.795 | 157.2** | 993.4** | 3.E+04** | 302.9** | 5.E+05** | 79.040** | 8.E+03** | 325.663** |
| 2352 | 2.029* | 8.56** | 7.286** | 108.392** | 10.08** | 75.678** | 1.896* | 9.7440** | 13.208** |
| 2353 | 1.181 | 9.21** | 2.999** | 35.9650** | 2.730** | 33.444** | 1.590 | 10.108** | 17.504** |
| 2356 | 1.844 | 13.6** | 5.531** | 53.6970** | 5.380** | 42.667** | 2.081** | 12.270** | 24.221** |
| 2357 | 1.860 | 19.2** | 17.23** | 118.518** | 19.30** | 113.868** | 1.654 | 28.249** | 166.62** |
| 2603 | 1.326 | 5.02** | 1.489 | 12.6710** | 1.651 | 13.1570** | 1.857 | 8.2240** | 13.419** |
| 2609 | 1.751 | 10.4** | 7.279** | 79.5060** | 3.847** | 31.7590** | 2.038* | 24.306** | 79.380** |
| 2610 | 1.674 | 8.98** | 6.205** | 46.4910** | 6.776** | 49.1980** | 1.581 | 5.3800** | 66.172** |
| 2801 | 2.298* | 11.0** | 7.189** | 66.9210** | 7.855** | 54.3530** | 1.656 | 12.883** | 20.179** |
| 9904 | 1.334 | 32.6** | 7.551** | 91.1010** | 10.75** | 109.848** | 2.131* | 42.644** | 41.302** |
| significant | 12 | 26 | 23 | 29 | 27 | 29 | 19 | 29 | 29 |
| number | | | | | | | | | |

note [symbol]
** means reaching the significance level of 0.01 [symbol]
* means reaching the significance level of 0.05.

Further, in order to verify the calculating method for systematic risk of the present invention again, the Dow Jones Industry Average Index is used for determining difference between each forecasted beta coefficient value of the ten conditions (OM₁¹, OM₁², GM₁¹, GM₁², GM₂¹, GM₂², GM₃¹, GM₃², GM₄¹ and GM₄²) and true beta value. As the following, the forecast accuracy is determined by Theil's U.

For calculating beta coefficient by single-factor model, the average Theil's U values of the 29 constituents of Dow Jones Industry Average Index with the OM₁¹, GM₁¹, GM₂¹, GM₃¹ and GM₄¹ are 12.9839%, 36.7918%, 39.6438%, 14.6405%, 9.9575% respectively, with the average Theil's U value of the GM₄¹ being close to zero most. According to the results shown in Table 7, the Theil's U values of the GM₁¹ and GM₂ are much higher than those of the others ¹ and it indicates that only whiting either return of the stock or return of the market during analyzing the beta value causes a lower forecasting accuracy. On the other hand, OM₁¹ with original return of the stock and original return of the market, GM₃¹ with whiten returns of the stock and whiten returns of the market and GM₄¹ with the true beta value cause higher forecasting accuracy. In particular, for the 29 constituents in Table 7, Theil's U values of the GM₄¹ are the lowest. Therefore, forecasting accuracy of the GM₄¹ is the best.

TABLE 7
Theil's U values of 29 constituents (Dow Jones Industry Average
Index) based on OM₁¹, GM₁¹, GM₂¹, GM₃¹ and GM₄¹

| | OM₁¹ | GM₁¹ | GM₂¹ | GM₃¹ | GM₄¹ |
|---|---|---|---|---|---|
| AA | 11.6638%* | 45.3135% | 44.4086% | 12.9184% | 7.9220%** |
| AXP | 7.9671%* | 41.1339% | 41.2675% | 20.6429% | 6.3319%** |
| BA | 15.8098%* | 38.5202% | 40.7848% | 17.6704% | 10.4232%** |
| C | 7.8574% | 41.5121% | 43.2212% | 7.3930%* | 6.2277%** |
| CAT | 11.3946% | 38.1607% | 43.0961% | 11.2170%* | 9.1730%** |
| DD | 7.5047%* | 32.6628% | 39.2446% | 8.7407% | 5.8141%** |
| DIS | 10.6780%* | 44.4357% | 43.0941% | 11.5606% | 7.1627%** |
| EK | 16.2945%* | 35.7102% | 37.9008% | 19.0867% | 11.1919%** |
| GE | 16.9470%* | 17.4483% | 35.4141% | 21.3471% | 14.6449%** |
| GM | 14.7711%* | 40.5213% | 41.3568% | 15.9064% | 10.4657%** |
| HD | 10.4425%* | 34.9372% | 41.7478% | 11.2875% | 8.3995%** |
| HON | 10.2315%* | 42.6687% | 44.4556% | 11.8849% | 8.5743%** |
| HPQ | 16.6391% | 50.3553% | 45.8256% | 16.3279%* | 12.7000%** |
| IBM | 12.1292%* | 39.1470% | 40.1152% | 13.6219% | 8.9777%** |
| INTC | 14.3455%* | 54.5844% | 53.8619% | 15.3527% | 11.4587%** |
| IP | 8.4686%* | 36.2240% | 36.0901% | 10.0572% | 7.4872%** |
| JNJ | 12.5340%* | 27.6236% | 34.1983% | 15.8667% | 8.5280%** |
| JPM | 14.2519% | 48.7657% | 46.6555% | 13.5382%* | 9.9932%** |
| KO | 13.0530%* | 25.1379% | 29.9571% | 14.4350% | 9.2073%** |
| MCD | 11.3791%* | 30.2920% | 36.3615% | 14.5131% | 10.0379%** |
| MMM | 11.2983% | 30.1041% | 36.0916% | 10.9268%* | 7.9338%** |
| MO | 15.5296%* | 28.7337% | 29.9987% | 18.0669% | 14.3145%** |
| MRK | 16.1777%* | 33.7411% | 35.6559% | 17.3200% | 11.9438%** |
| MSFT | 9.9236% | 39.2845% | 45.0473% | 9.3590%* | 7.2772%** |
| PG | 24.7484%* | 30.7413% | 35.4472% | 29.3912% | 21.5718%** |
| T | 15.9395%* | 38.7017% | 31.7227% | 17.2001% | 12.0586%** |
| UTX | 14.3615% | 37.9876% | 41.2007% | 13.9616%* | 11.1148%** |
| WMT | 15.7924% | 35.3604% | 40.1733% | 13.6720%* | 10.4177%** |
| XOM | 8.5562%* | 27.1520% | 35.2754% | 11.3085% | 7.4128%** |
| average | 12.9893%* | 36.7918% | 39.6438% | 14.6405% | 9.9575%** |

note [symbol]
** is the best forecasting accuracy [symbol]
* means the forecasting accuracy is inferior to the best forecast accuracy.

The forecast performances of GM₄¹ of the present invention relative to OM₁¹, GM₁¹, GM₂¹, and GM₃¹ are shown in Table 8. Based on data of the Dow Jones Industry Average Index, the average forecast performances of GM₄¹ of the present invention relative to OM₁¹, GM₁¹, GM₂¹, and GM₃¹ are 23.2502%, 70.8095%, 74.1235% and 30.9736% respectively, and it is shown that the forecasting accuracy of GM₄¹ is much better than those of the others.

TABLE 8
The forecast performances of GM₄¹ relative to OM₁¹, GM₁¹, GM₂¹,
and GM₃¹ (Dow Jones Industry Average Index)

| | OM₁¹ | GM₁¹ | GM₂¹ | GM₃¹ |
|---|---|---|---|---|
| AA | 32.0802% | 82.5173% | 82.1610% | 38.6764% |
| AXP | 20.5243% | 84.6066% | 84.6564% | 69.3265% |
| BA | 34.0717% | 72.9411% | 74.4435% | 41.0136% |
| C | 20.7409% | 84.9980% | 85.5912% | 15.7625% |
| CAT | 19.4973% | 75.9622% | 78.7150% | 18.2227% |
| DD | 22.5276% | 82.1998% | 85.1851% | 33.4832% |
| DIS | 32.9209% | 83.8807% | 83.3789% | 38.0420% |
| EK | 31.3147% | 68.6591% | 70.4705% | 41.3627% |
| GE | 13.5842% | 16.0671% | 58.6468% | 31.3965% |
| GM | 29.1471% | 74.1723% | 74.6940% | 34.2042% |
| HD | 19.5638% | 75.9582% | 79.8803% | 25.5856% |
| HON | 16.1975% | 79.9050% | 80.7127% | 27.8558% |
| HPQ | 23.6734% | 74.7792% | 72.2862% | 22.2186% |
| IBM | 25.9829% | 77.0667% | 77.6202% | 34.0939% |
| INTC | 20.1235% | 79.0074% | 78.7258% | 25.3638% |
| IP | 11.5883% | 79.3307% | 79.2540% | 25.5537% |
| JNJ | 31.9606% | 69.1277% | 75.0630% | 46.2521% |
| JPM | 29.8816% | 79.5078% | 78.5809% | 26.1855% |
| KO | 29.4616% | 63.3727% | 69.2648% | 36.2153% |
| MCD | 11.7859% | 66.8627% | 72.3941% | 30.8352% |
| MMM | 29.7789% | 73.6455% | 78.0177% | 27.3914% |
| MO | 7.8240% | 50.1821% | 52.2828% | 20.7692% |
| MRK | 26.1708% | 64.6016% | 66.5025% | 31.0401% |
| MSFT | 26.6673% | 81.4756% | 83.8454% | 22.2433% |
| PG | 12.8353% | 29.8278% | 39.1437% | 26.6045% |
| T | 24.3474% | 68.8421% | 61.9873% | 29.8921% |
| UTX | 22.6067% | 70.7409% | 73.0228% | 20.3904% |
| WMT | 34.0335% | 70.5386% | 74.0681% | 23.8030% |
| XOM | 13.3633% | 72.6990% | 78.9860% | 34.4497% |
| average | 23.2502% | 70.8095% | 74.1235% | 30.9736% |

Referring to Table 9, average Theil's U values and Friedman's chi-square distribution statistics under OM₁¹, OM₁², GM₁¹, GM₁², GM₂¹, GM₂², GM₃¹, GM₃², GM₄¹ and GM₄² with data of Dow Jones Industry Average Index are listed. It is known that forecasting accuracy of GM₄¹ is most reliable, with Friedman's chi-square distribution statistics of 28 in 29 constituents falling with a range smaller than 15%. Regarding Friedman's chi-square distribution statistics of OM₁¹ and GM₃¹, there are respectively 20 and 17 in 29 constituents falling with a range smaller than 15%. Most Friedman's chi-square distribution statistics of GM₁² and GM₂² fall with a range greater than 60%. Most Friedman's chi-square distribution statistics of OM₁², GM₁¹ and GM₂¹ fall within a range between 30% to 45%. GM₃² and GM₄² have averagely distributed Friedman's chi-square distribution statistics.

TABLE 9
distribution of Theil's U values and Friedman's chi-square
distribution statistics under OM₁¹, OM₁², GM₁¹, GM₁², GM₂¹, GM₂², GM₃¹,
GM₃², GM₄¹ and GM₄² with 29 constituents of Dow Jones Industry Average
Index

| | Theil's U | | | | | | | Amount |
|---|---|---|---|---|---|---|---|---|
| | <15% | 15~30% | 30~45% | 45~60% | >60% | Friedman chi-square | | of constituent |
| OM₁¹ | 20 | 9 | 0 | 0 | 0 | chi-square | 520.3 | 29 |
| | | | | | | evaluation | | |
| OM₁² | 0 | 3 | 16 | 9 | 1 | Degrees of | 36 | 29 |
| | | | | | | freedom | | |
| GM₁¹ | 0 | 5 | 20 | 4 | 0 | P-VALUE | 0 | 29 |
| GM₁² | 0 | 0 | 0 | 0 | 29 | | | 29 |
| GM₂¹ | 0 | 2 | 23 | 4 | 0 | | | 29 |
| GM₂² | 0 | 0 | 0 | 0 | 29 | | | 29 |
| GM₃¹ | 17 | 12 | 0 | 0 | 0 | | | 29 |
| GM₃² | 0 | 3 | 12 | 11 | 3 | | | 29 |
| GM₄¹ | 28 | 1 | 0 | 0 | 0 | | | 29 |
| GM₄² | 0 | 1 | 7 | 8 | 13 | | | 29 |

note [symbol] Friedman critical value is 50.892 with the significance level at 0.01.

As has been discussed above, estimation of beta coefficient by any of said conventional models or methods described above is still not accurate and stable enough. The present invention performing the single- or two- factor models with returns of the stock and the market from original closing prices and closing index to obtain a true beta coefficient value, and whiting the beta coefficient value to forecast future beta coefficient value. As a result, variation between true and forecasted beta coefficients is diminished, so that the accuracy and stability of estimating systematic risk is improved.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A calculating method for systematic risk, comprising the steps of:
calculating and obtaining predetermined number of true values of beta coefficient of a stock;
establishing an original data series from the true values of beta coefficient;
taking the accumulated generating operation (AGO) on the original data series to obtain a accumulated generating operation series;
applying the MEAN operation to the accumulated generating operation series to obtain a mean series;
using the original data series and the mean series to establish an grey differential equation;
expressing the grey differential equation into a grey differential equation matrix;
calculating particular parameters in the grey differential equation based on the least square method;
applying the particular parameters to a whiting responsive equation to obtain a forecasting value of the accumulated generating operation series; and
taking the inverse accumulated generating operation (IAGO) on the forecasting value of the accumulated generating operation series to obtain a forecasting value of beta coefficient.

2. The calculating method for systematic risk as defined in claim 1, wherein calculations of true values of beta coefficient are performed by the Fama-Macbeth regression model.

3. The calculating method for systematic risk as defined in claim 2, wherein the Fama-Macbeth regression model is Single-factor model.
